(19) United States
(12) Patent Application Publication
(10) Pub. No.: US 2022/0198020 A1
(43) Pub. Date: Jun. 23, 2022

(54) ENCRYPTING TABLE SIGNATURES

(71) Applicant: Hewlett-Packard Development Company, L.P., Spring, TX (US)

(72) Inventors: Tsue-Yi Huang, Taipei City (TW); Heng-Fu Chang, Taipei City (TW); Ming Chang Hung, Taipei City (TW); Ming Chu Chen, Taipei City (TW)

(73) Assignee: Hewlett-Packard Development Company, L.P., Spring, TX (US)

(21) Appl. No.: 17/606,094

(22) PCT Filed: Aug. 28, 2019
(86) PCT No.: PCT/US2019/048471

§ 371 Date: Oct. 25, 2021

(51) Int. Cl. G06F 21/57; G06F 21/60

(52) U.S. Cl. CPC G06F 21/572; G06F 2221/033; G06F 21/602

(57) ABSTRACT

In some examples, a computing device includes a processing resource and a memory resource storing instructions to cause the processing resource to generate a table having a corresponding signature, encrypt the signature during a power-on self-test (POST) sequence by a basic input/output system (BIOS) of the computing device, and decrypt the signature in response to

### BACKGROUND

Computing devices can utilize an interface to initialize hardware included in the computing device during the startup sequence of the computing device. For example, a basic input/output system (BIOS) can provide runtime services for an operating system (OS) and/or other programs. The Unified Extensible Firmware Interface (UEFI) may additionally be utilized as an interface between an OS of the computing device and firmware of the computing device.

### BRIEF DESCRIPTION OF THE DRAWINGS

FIG. 1 illustrates an example of a computing device for encrypting table signatures consistent with the disclosure.

FIG. 2 illustrates an example of a computing device for encrypting table signatures consistent with the disclosure.

FIG. 3 illustrates a block diagram of an example system consistent with the disclosure.

FIG. 4 illustrates an example of a method for encrypting table signatures consistent with the disclosure.

### DETAILED DESCRIPTION

A computing device can utilize the BIOS to perform certain actions. As used herein, the term “BIOS” refers to a non-volatile firmware to perform hardware initialization during a startup sequence of the computing device and to provide runtime services for OS's and/or other programs. For example, as a computing device is started (e.g., booted), the BIOS can initialize hardware of the computing device.

As used herein, the term “computing device” can be, for example, a laptop computer, a notebook computer, a desktop computer, and/or a mobile device (e.g., a smart phone, tablet, personal digital assistant, smart glasses, a wrist-worn device, etc.), among other types of computing devices. As used herein, a mobile device can include devices that are (or can be) carried and/or worn by a user. For example, a mobile device can be a phone (e.g., a smart phone), a tablet, a personal digital assistant (PDA), smart glasses, and/or a wrist-worn device (e.g., a smart watch), among other types of mobile devices.

As described above, a computing device can utilize UEFI to interface between an OS of the computing device and firmware of the computing device. As used herein, the term “UEFI” refers to a specification that defines a software interface between an OS and platform firmware. For example, UEFI can define a software interface between an OS of the computing device and firmware of the computing device. As used herein, the term “operating system” refers to software that supports a computing device's basic functions, such as scheduling tasks, executing applications, and/or controlling peripheral devices, As used herein, the term “firmware” refers to software that provides low-level control of particular hardware of a computing device.

As described above, UEFI can be a specification defining an interface between an OS and hardware of a computing device. The UEFI specification can define signatures included in memory of the BIOS. As used herein, the term “signature” refers to an authenticator to verify authenticity of an executable instruction. As described above, the BIOS can include executable instructions to provide services to an OS and/or other programs of the computing device. The BIOS can include function pointers to point to the executable instructions stored in the BIOS. As used herein, the term “function pointer” refers to a mapping of a memory location where executable instructions are stored.

The signatures defined by the UEFI specification can be unencrypted and pre-defined. Accordingly, these signatures can be public. Therefore, if a malicious user such as a hacker can access the BIOS memory, the malicious user can determine a function pointer by searching the signatures. The malicious user may, in some examples, redirect a function pointer to malicious code which may be executed.

Encrypting table signatures, according to the disclosure, can allow for signatures corresponding to tables to be encrypted during power-on self-test (POST) of the computing device. Encrypting the table signatures can prevent a user from determining a function pointer by searching the signatures, as the signatures are encrypted. The encrypted table signatures can prevent a malicious user from redirecting a function pointer to malicious code. Encrypting table signatures according to the disclosure can provide strong security without extra hardware, applications, OS changes, driver changes, and/or any impact on user experience of the computing device.

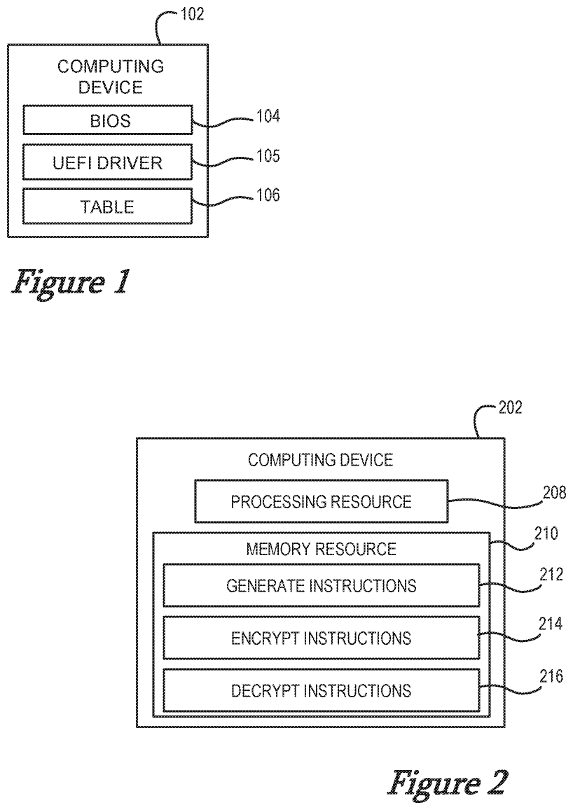

FIG. 1 illustrates an example of a computing device for encrypting table signatures consistent with the disclosure. The computing device 102 can include a BIOS 104, caller UEFI driver 105, and table 106.

As illustrated in FIG. 1, the computing device 102 can include a table 106. As used herein, the term “table” refers to an arrangement of data. The table 106 can be an extensible firmware interface (EFI) table. As used herein, the term “EFI table” refers to an arrangement of data relating to the UEFI standard. For example, the EFl table 106 can be UEFI data. The table 106 can be an EFl system table, an EFI boot services table, an EFI runtime services table, and/or any other EFI table.

The computing device 102 can generate the EFI table 106 during a power-on self-test (POST) sequence by the BIOS 104. As used herein, the term “POST sequence” refers to a process performed by firmware and/or software routines after a computing device is powered on to determine whether hardware of the computing device is working correctly. For example, the computing device 102 can run a POST sequence when powered on to determine whether certain hardware of the computing device 102 (e.g., random access memory (RAM), disk drives, peripheral devices, and/or other hardware) is working correctly.

As described above, the UEFI specification can define signatures. The signatures can correspond to different EFI table types. For example, a first signature can correspond to an EFI system table, a second signature can correspond to an EFI boot services table, a third signature can correspond to an EFI runtime services table, etc.

The BIOS 104 can encrypt a signature corresponding to the EFI table 106 during the POST sequence. As used herein, the term “encrypt” refers to translation of plaintext data to ciphered data using a key. For example, the BIOS 104 can encrypt a signature from plaintext data to ciphered data. Encrypting signatures corresponding to EFI tables can prevent a malicious user from reading plaintext signatures, as the user is unable to determine the meaning of the ciphered data (e.g., the encrypted signatures). In some examples, the BIOS 104 can encrypt the signatures via bit-wise encryption. In some examples, the BIOS 104 can encrypt the signatures by replacing the UEFI signature with a pre-determined signature, For example, the plaintext signature for the EFI table 106 may be “IBITSYS”, and the BIOS 104 can encrypt the plaintext signature by replacing the UEFI signature (e.g., IBITSYS) with a pre-determined signature (e.g., “CNETSYS”).

Although encryption schemes are described above as including bit-wise encryption and/or replacing a UEFI signature with a pre-determined signature, examples of the disclosure are not so limited. For example, the BIOS 104 can encrypt the signatures via any other method of encryption.

The BIOS 104 can decrypt the signatures in response to an input. The input can be, for example, a call to the BIOS from a caller UEFI driver 105 and/or a hardware control transfer, as is further described herein.

In some examples, the input can be a call to the BIOS 104 from a caller UEFI driver 105. As used herein, the term “call” refers to a request of a service. As used herein, the term “driver” refers to a computer program that operates and/or controls a particular device of a computing device. For example, a caller UEFI driver 105 can request a service from the BIOS 104 by transmitting a call to the BIOS 104, as is further described herein. The caller UEFI driver 105 can transmit a call to the BIOS 104 after the EFI table 106 is installed in memory during the POST sequence.

The caller UEFI driver 105 can be a particular caller UEFI driver. The particular caller UEFI driver 105 may be directed to use an encrypted signature for the EFI table 106 and can call the BIOS 104 to decrypt the encrypted signature for the EFI table 106. The BIOS 104 can, accordingly, decrypt the signature for the EFI table 106 in response to the call by the particular caller UEFI driver 105. As used herein, the term “decrypt” refers to translation of ciphered data to plaintext data using a key. For example, the encrypted signature may be CNETSYS and the BIOS 104 can decrypt the encrypted signature to its plaintext form (e.g., IBITSYS).

After use by the particular caller UEFI driver 105, the BIOS 104 can re-encrypt the signature for the EFI table 106. For example, the particular caller UEFI driver 105 may utilize the signature for the EFI table 106 to cause an operation by a particular device of the computing device 102 during the POST sequence of the computing device 102, and once complete, the BIOS 104 can re-encrypt the signature for the EFI table 106. For example, the BIOS 104 can re-encrypt the plaintext signature for the EFI table 106 (e.g., IBITSYS) to a ciphered signature (e.g., CNETSYS).

Another caller UEFI driver (e.g., caller UEFI driver 105, or a caller UEFI driver that is a different caller UEFI driver than caller UEFI driver 105) may make a call to the BIOS 104. For example, the another caller UEFI driver may utilize the signature for the EFI table 106 to cause an operation by another device of the computing device 102 during the POST sequence of the computing device 102. The another caller UEFI driver can request a service (e.g., decryption) from the BIOS 104 by transmitting a call to the BIOS 104 to decrypt the signature for the EFI table 106.

The BIOS 104 can re-encrypt the signature for the EFI table 106 after use by the another caller UEFI driver. For example, the another caller UEFI driver may utilize the signature for the EFI table 106 to cause an operation by the another device of the computing device 102 during the POST sequence of the computing device 102, and once complete, the BIOS 104 can re-encrypt the signature for the EFI table 106. For example, the BIOS 104 can re-encrypt the plaintext signature for the EFI table 106 (e.g., IBITSYS) to a ciphered signature (e.g., CNETSYS).

In some examples, the input can be a hardware control transfer from the BIOS 104 to the OS of the computing device 102. For example, during POST, the BIOS 104 can control the hardware of the computing device (e.g., as the BIOS 104 determines whether certain hardware of the computing device 102 are working correctly. According to the UEFI standard, the signatures for the EFI table 106 are to be decrypted prior to POST being completed and hardware control transferred to the OS of the computing device 102. Accordingly, the BIOS 104 can decrypt the signature for the EFI table 106 prior to the BIOS 104 transferring hardware control to the OS.

Encrypting table signatures, according to the disclosure, can allow for signatures corresponding to EFI tables to be encrypted by a BIOS of the computing device during a POST sequence of a computing device. Encrypting the signatures corresponding to EFI tables during the POST sequence can prevent a malicious user from redirecting a function pointer to malicious code, providing for strong security without extra hardware, applications, OS changes, driver changes, and/or any impact on user experience of the computing device. The BIOS can decrypt the signatures prior to the POST sequence finishing and transferring control of the computing device hardware to the OS.

FIG. 2 illustrates an example of a computing device 202 for encrypting table signatures consistent with the disclosure. As described herein, the computing device 202 may perform functions related to encrypting table signatures. Although not illustrated in FIG. 2, the computing device 202 may include a processor and a machine-readable storage medium. Although the following descriptions refer to a single processor and a single machine-readable storage medium, the descriptions may also apply to a system with multiple processors and multiple machine-readable storage mediums. In such examples, the computing device 202 may be distributed across multiple machine-readable storage mediums and the computing device 202 may be distributed across multiple processors. Put another way, the instructions executed by the computing device 202 may be stored across multiple machine-readable storage mediums and executed across multiple processors, such as in a distributed or virtual computing environment.

Processing resource 208 may be a central processing unit (CPU), a semiconductor-based microprocessor, and/or other hardware devices suitable for retrieval and execution of machine-readable instructions 212, 214, 216 stored in a memory resource 210. Processing resource 208 may fetch, decode, and execute instructions 212, 214, 216. As an alternative or in addition to retrieving and executing instructions 212, 214, 216, processing resource 208 may include a plurality of electronic circuits that include electronic components for performing the functionality of instructions 212, 214, 216.

Memory resource 210 may be any electronic, magnetic, optical, or other physical storage device that stores executable instructions 212, 214, 216 and/or data. Thus, memory resource 210 may be, for example, Random Access Memory (RAM), an Electrically-Erasable Programmable Read-Only Memory (EEPROM), a storage drive, an optical disc, and the like. Memory resource 210 may be disposed within the computing device 202, as shown in FIG. 2. Additionally, memory resource 210 may be a portable, external or remote storage medium, for example, that causes the computing device 202 to download the instructions 212, 214, 216 from the portable/external/remote storage medium.

The computing device 202 may include generate instructions 212 stored in the memory resource 210 and executable by the processing resource 208 to generate a table having a corresponding signature. The table can be an EFI table, such as an EFI system table, an EFI boot services table, an EFI runtime services table, and/or any other EFI table. The computing device 202 can generate, by a BIOS of the computing device 202, the table during a POST sequence of the computing device 202.

The computing device 202 may include encrypt instructions 214 stored in the memory resource 210 and executable by the processing resource 208 to encrypt the signature during the POST sequence by the BIOS of the computing device 202. For example, the signature can be plaintext data, and the BIOS of the computing device 202 can translate the plaintext data to ciphered data using a key. The BIOS can encrypt the signature using bit-wise encryption, replacement of the signature with a pre-determined signature, and/or any other type of encryption method.

The computing device 202 may include decrypt instructions 216 stored in the memory resource 210 and executable by the processing resource 208 to decrypt the signature in response to an input. In some examples, the input can be a call to the BIOS from a caller UEFI driver. For example, the caller UEFI driver can request a decrypt service from the BIOS such that the BIOS decrypts the signature for use by the caller UEFI driver, and re-encrypts the signature following use of the signature by the caller UEFI driver. In some examples, the input can be a hardware control transfer. For example, according to the UEFI standard, the signatures for the table are to be decrypted prior to POST being completed and hardware control transferred from the BIOS to the OS of the computing device 202. Accordingly, the BIOS can decrypt the signature for the table prior to the BIOS transferring hardware control to the OS to complete the POST sequence.

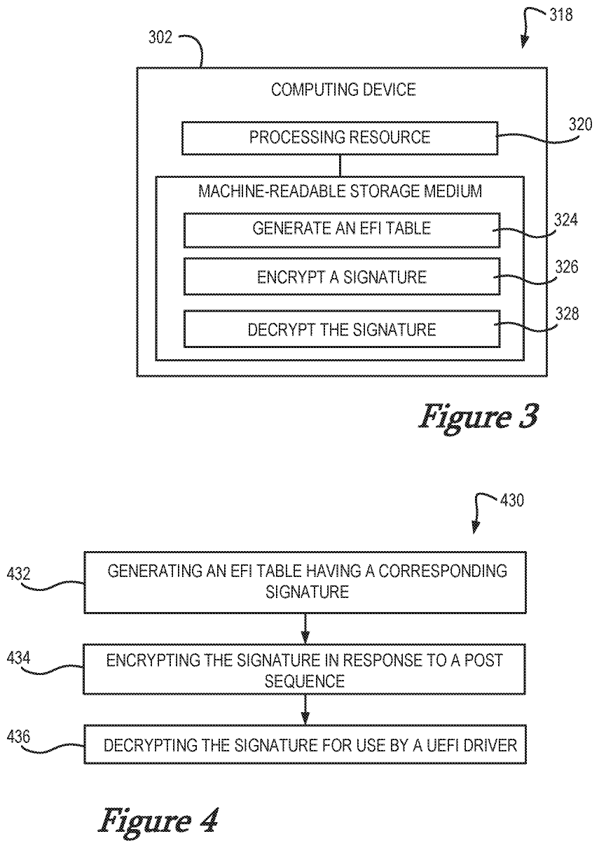

FIG. 3 illustrates a block diagram of an example system 318 consistent with the disclosure. In the example of FIG. 3, system 318 includes a computing device 302. The computing device 302 can include a processing resource 320 and a machine-readable storage medium 322. Although the following descriptions refer to a single processing resource and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processing resource 320 may be a central processing unit (CPU), microprocessor, and/or other hardware device suitable for retrieval and execution of instructions stored in machine-readable storage medium 322. In the particular example shown in FIG. 3, processing resource 320 may receive, determine, and send instructions 324, 326, and 328. As an alternative or in addition to retrieving and executing instructions, processing resource 320 may include an electronic circuit comprising a number of electronic components for performing the operations of the instructions in machine-readable storage medium 322. With respect to the executable instruction representations or boxes described and shown herein, it should be understood that part or all of the executable instructions and/or electronic circuits included within one box may be included in a different box shown in the figures or in a different box not shown.

Machine-readable storage medium 322 may be any electronic, magnetic, optical, or other physical storage device that stores executable instructions. Thus, machine-readable storage medium 322 may be, for example, Random Access Memory (RAM), an Electrically-Erasable Programmable Read-Only Memory (EEPROM), a storage drive, an optical disc, and the like. The executable instructions may be “installed” on the system 318 illustrated in FIG. 3. Machine-readable storage medium 322 may be a portable, external or remote storage medium, for example, that allows the system 318 to download the instructions from the portable/external/remote storage medium. In this situation, the executable instructions may be part of an “installation package”. As described herein, machine-readable storage medium 322 may be encoded with executable instructions associated with encrypting table signatures.

Generate an EFI table instructions 324, when executed by a processor such as processing resource 320, may cause system 318 to generate an EFI table during a POST sequence by a BIOS of the computing device 302. The EFI table can be, for example, an EFI system table, an EFI boot services table, an EFI runtime services table, and/or any other EFI table.

Encrypt a signature instructions 326, when executed by a processor such as processing resource 320, may cause system 318 to encrypt a signature corresponding to the EFI table during the POST sequence. For example, the signature can be plaintext data, and the BIOS of the computing device 302 can translate the plaintext data to ciphered data using a key. The BIOS can encrypt the signature using bit-wise encryption, replacement of the signature with a pre-determined signature, and/or any other type of encryption method.

Decrypt a signature instructions 328, when executed by a processor such as processing resource 320, may cause system 318 to decrypt the signature in response to an input. In some examples, the input can be a call to the BIOS from a caller UEFI driver. For example, the caller UEFI driver can request a decrypt service from the BIOS such that the BIOS decrypts the signature for use by the caller UEFI driver, and re-encrypts the signature following use of the signature by the caller UEFI driver. In some examples, the input can be a hardware control transfer. For example, according to the UEFI standard, the signatures for the table are to be decrypted prior to POST being completed and hardware control transferred from the BIOS to the OS of the computing device 302. Accordingly, the BIOS can decrypt the signature for the table prior to the BIOS transferring hardware control to the OS to complete the POST sequence.

FIG. 4 illustrates an example of a method 430 for encrypting table signatures consistent with the disclosure. For example, method 430 can be performed by a computing device (e.g., computing device 102, 202, 302, previously described in connection with FIGS. 1-3, respectively).

At 432, the method 430 includes generating, by a computing device, an EFI table having a corresponding signature in response to a POST sequence of the computing device. The EFI table can be, for example, an EFI system table, an EFI boot services table, an EFI runtime services table, and/or any other EFI table.

At 434, the method 430 includes encrypting, by a BIOS of the computing device, the signature in response to a POST sequence of the computing device commencing. The signature can be, for example, plaintext data according to the UEFI specification, and the BIOS of the computing device can translate the plaintext data to ciphered data using a key. The BIOS can encrypt the signature using bit-wise encryption, replacement of the signature with a pre-determined signature, and/or any other type of encryption method.

At 436, the method 430 includes decrypting, by the BIOS of the computing device, the signature for use by a caller UEFI driver in response to a call to the BIOS from the caller UEFI driver. For example, the caller UEFI driver can request a decrypt service from the BIOS such that the BIOS decrypts the signature for use by the caller UEFI driver.

In some examples, the method 430 includes encrypting, by the BIOS, the signature after use by the caller UEFI driver. For example, the BIOS can re-encrypt the signature following use of the signature by the caller UEFI driver. Re-encrypting the signature following use by the caller UEFI driver can keep the signature encrypted during the remaining portion of the POST sequence until the caller UEFI driver or another caller UEFI driver is to utilize the signature, and/or the POST sequence is to cease and control of the hardware is to be transferred from the BIOS to the OS of the computing device.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. A computing device, comprising:
a processing resource; and
a memory resource storing non-transitory machine-readable instructions to cause the processing resource to:
generate a table having a corresponding signature;
encrypt the signature during a power-on self-test (POST) sequence by a basic input/output system (BIOS) of the computing device; and
decrypt the signature in response to an input.

2. The computing device of claim 1, wherein the input is a call to the BIOS from a caller unified extensible firmware interface (UEFI) driver.

3. The computing device of claim 2, including instructions to cause the processing resource to decrypt the signature by the BIOS in response to the call by the caller UEFI driver.

4. The computing device of claim 3, including instructions to cause the processing resource to encrypt the signature by the BIOS after use by the caller UEFI driver.

5. The computing device of claim 1, wherein the input is a hardware control transfer from the BIOS to an operating system (OS) of the computing device.

6. The computing device of claim 5, including instructions to cause the processing resource to decrypt the signature by the BIOS prior to the BIOS transferring hardware control to the OS.

7. The computing device of claim 1, wherein the table is an extensible firmware interface (EFI) table.

8. A non-transitory machine readable medium storing instructions executable by a processing resource to cause the processing resource to:
generate an extensible firmware interface (EFI) table during a power-on self-test (POST) sequence by a basic input/output system (BIOS);
encrypt a signature corresponding to the EFI table during the POST sequence; and
decrypt the signature in response to an input.

9. The medium of claim 8, wherein:
the input is a call to the BIOS from a particular caller unified extensible firmware interface (UEFI) driver; and
the instructions to decrypt the signature include instructions to decrypt the signature in response to the call to the BIOS from the particular caller UEFI driver.

10. The medium of claim 9, comprising instructions to re-encrypt the signature by the BIOS after use by the particular caller UEFI driver.

11. The medium of claim 10, wherein:
the input is a call to the BIOS from another caller UEFI driver; and
the instructions to decrypt the signature include instructions to decrypt the signature in response to the call to the BIOS from the another caller UEFI driver.

12. The medium of claim 11, comprising instructions to re-encrypt the signature by the BIOS after use by the another caller UEFI driver.

13. A method, comprising:
generating, by a computing device, an extensible firmware interface (EFI) table having a corresponding signature in response to a power-on self-test (POST) sequence of the computing device;
encrypting, by a basic input/output system (BIOS) of the computing device, the signature in response to the power-on self-test (POST) sequence of the computing device commencing; and
decrypting, by the BIOS, the signature for use by a unified extensible firmware interface (UEFI) caller driver in response to a call to the BIOS from the caller UEFI driver.

14. The method of claim 13, wherein the method includes encrypting, by the BIOS, the signature after use by the caller UEFI driver.

15. The method of claim 13, wherein the method includes encrypting the signature by at least one of:
bit-wise encryption; and
replacing the signature with a pre-determined signature.
